(19) United States
(12) Patent Application Publication
(10) Pub. No.: US 2025/0379243 A1
(43) Pub. Date: Dec. 11, 2025

(54) MEMBRANE STACK AND HUMIDIFIER COMPRISING A MEMBRANE STACK AND A METHOD FOR MANUFACTURING THE MEMBRANE STACK

(71) Applicant: MAHLE International GmbH, Stuttgart (DE)

(72) Inventor: Sven Alexander Kaiser, Waiblingen (DE)

(21) Appl. No.: 19/228,702

(22) Filed: Jun. 4, 2025

(30) Foreign Application Priority Data
Jun. 5, 2024 (DE) 102024115681.3

(51) Int. Cl. H01M 8/04119

(52) U.S. Cl. CPC H01M 8/04149

(57) ABSTRACT

A membrane stack for a fuel cell humidifier includes water vapor-permeable, airtight membranes spaced apart in a stack with alternating first and second spacers. The stack enables cross-flow of humid exhaust and dry supply air. Each first spacer is separated from the adjacent membrane by a protective layer, with both connected in a direct, material-locking manner.

### CROSS REFERENCE TO RELATED APPLICATIONS

This application claims priority to DE-102024115681.3, filed Jun. 5, 2024, the contents of which is hereby incorporated by reference in its entirety.

### TECHNICAL FILED

The disclosure relates to a membrane stack for a humidifier of a fuel cell system with at least one fuel cell. The disclosure also relates to a humidifier for a fuel cell system with the membrane stack and a method for manufacturing the membrane stack.

### BACKGROUND

In a membrane stack, flat membranes and spacers are stacked alternately in a stacking direction. The spacers form channels between the membranes through which fluid can flow alternately in directions perpendicular to each other and perpendicular to the stacking direction. The respective channels are assigned to two different air flows. The membranes of the membrane stack are made of a material which is permeable to water vapor and airtight, so that the two air streams can flow through the membrane stack without mixing and exchange humidity with each other. Such a membrane stack can be used, for example, in a humidifier of a fuel cell system with at least one fuel cell for humidifying dry supply air flowing to the fuel cell with humid exhaust air flowing from the fuel cell.

The membranes are usually formed in multiple layers during manufacture. A membrane material which is permeable to water vapor and airtight can be bonded to a protective material on both sides or on one side. The protective material can protect the membrane material from tearing during the manufacture of the membrane stack and from abrasion on the spacers during operation of the membrane stack. Unfortunately, a stable and permanent connection between the membrane material and the protective material is rarely achieved due to the difficulty of bonding the materials together and/or insufficient thickness of the materials. During operation of the membrane stack, this can lead to delamination of the membrane material from the protective material and thus to leakage of the membrane stack.

### SUMMARY

The purpose of the disclosure is therefore to provide an improved or at least alternative design for a membrane stack of the generic type, in which the disadvantages described are overcome. The disclosure also aims to provide a corresponding humidifier with the membrane stack and a corresponding method for manufacturing the membrane stack.

According to some implementations of the disclosure, this problem is solved by the scope of the independent claims. Advantageous embodiments are the scope of the dependent claims.

The present disclosure is based on the general idea of applying the required support layer or protective layer to the spacer or distance holder instead of to the membrane.

A membrane stack according to some implementations of the disclosure is intended or designed for a humidifier of a fuel cell system with at least one fuel cell. The membrane stack comprises several flat membranes, wherein the membranes are stacked in a stacking direction at a distance from one another. The membranes are permeable to water vapor and airtight. Furthermore, the membrane stack has several first spacers and several second spacers. The first spacers and the second spacers are arranged or stacked alternately between the membranes in the stacking direction. The membrane stack can be flowed through perpendicularly to the stacking direction through the first spacers in a first flow direction and through the second spacers in a second flow direction. The first flow direction and the second flow direction are perpendicular to each other and perpendicular to the stacking direction. The respective first spacer and the respective membrane adjacent to the respective first spacer are connected to each other in sections at the edges—i.e., in a limited section of their edges—and are directly bonded to each other. Preferably, the respective first spacer and the respective membrane adjacent to the respective first spacer are welded or glued together. According to some implementations of the disclosure, a protective layer is arranged between the respective first spacer and the respective membrane adjacent to the respective first spacer. The respective protective layer and the respective first spacer adjacent to the respective protective layer are connected to each other in sections at the edges—i.e., in a limited section of their edges—and are directly bonded to each other. Preferably, the respective protective layer and the respective first spacer adjacent to the respective protective layer are welded or bonded to one another.

In the membrane stack according to some implementations of the disclosure, the respective first spacer and the respective protective layer can be freely matched to each other in terms of materials. Furthermore, the respective protective layer can be securely connected to the respective first spacer due to the sufficient thickness of the latter. This allows a stable and permanent connection between the respective first spacer and the respective protective layer to be achieved. The respective membrane is separated from the respective protective layer using the respective first spacer or connected separately from the respective protective layer. This also allows a stable and permanent connection between the respective first spacer and the respective membrane to be achieved. Accordingly, during operation of the membrane stack, delamination of the protective layers from the membranes and/or from the first spacers and consequently leakage of the membrane stack can be prevented.

The protective layer can be made of plastic, such as PET or PPS. The respective protective layer can be made of a woven material or a non-woven material or fleece. The respective first spacer and/or the respective second spacer may be made of plastic. The respective first spacer and/or the respective second spacer may, for example, each have a wave structure and/or a rib structure and/or a different flow-through structure. The respective first spacers and the respective second spacers may differ from each other or have a different structure. This allows the respective first spacers and the respective second spacers or the channels formed by the respective first spacers and the respective second spacers in the membrane stack to be adapted to the respective air flows.

The respective first spacer and the respective protective layer adjacent to the respective first spacer can lie directly against each other in two opposing first connection regions at the edges and be connected to each other in a material-locking manner. The respective first connection regions extend in the first flow direction. The respective protective layer can be connected in a material-locking manner exclusively in the first two connection regions with the respective first spacer and can lie loosely on the respective first spacer between the first two connection regions. This ensures a secure and permanent connection between the protective layer and the first spacer, while also making it easy to establish the connection. The respective first spacer can be connected to the respective protective layer adjacent to the respective first spacer at specific points, in a linear fashion, or over an area in a material-locking manner. With point-to-point connection, the protective layer can only be connected to the first spacer at specific points, allowing the connection to be established quickly. In addition, heat input into the first spacer and into the protective layer can be reduced. With the line-like connection, the protective layer can be connected to the first spacer in a line, thereby creating a continuous and secure connection. When connecting across a surface, a continuous and therefore particularly secure connection can be established between the protective layer and the first spacer.

The respective first spacer and the respective membrane adjacent to the respective first spacer can lie directly against each other in two opposing second connection regions at the edges and be connected to each other in a material-locking manner. The respective second connection regions extend in the first flow direction. The respective membrane can be connected in a material-locking manner exclusively in the two second connection regions with the respective first spacer and lie loosely between the two second connection regions on the respective protective layer arranged between the membrane and the first spacer. Here too, a secure and permanent connection between the respective first spacer and the respective membrane can be easily achieved. A channel through which fluid can flow in the direction of the primary flow may be formed between the two second connection regions. The respective channel is airtight, perpendicular to the first flow direction or in the second flow direction through the two second connection regions and in the stacking direction through the two membranes adjacent to the respective first spacer. In the respective second connection regions, the respective first spacer and the respective membrane can be connected to each other in an airtight manner as required. The two protective layers are also arranged in the respective channel, but they have no influence on the flow through the respective channel.

The membrane stack may be cuboid in shape. The respective membrane and/or the respective protective layer and/or the respective first spacer and/or the respective second spacer may have a quadrangular, preferably rectangular, cross-section perpendicular to the stacking direction. In particular, the respective protective layer and the respective first spacer may have a square, preferably rectangular, cross-section perpendicular to the stacking direction. The respective first connection regions can then be arranged on opposite sides of the respective protective layer and the respective first spacer. In addition, the respective membrane and the respective first spacer can each have a square, preferably rectangular, cross-section perpendicular to the stacking direction. The respective second connection regions can then be arranged on opposite sides of the respective membrane and the respective first spacer.

At the respective first spacer, the respective first connection region and the respective second connection region may be arranged on the same sides of the respective first spacer as appropriate. At the respective first spacer, the respective first connection region and the respective second connection region can be spaced apart from each other perpendicular to the first flow direction or along the second flow direction or in the second flow direction. In the respective first spacer, the first connection regions can be located perpendicular to the first flow direction or along the second flow direction or in the second flow direction relative to the second connection regions on the inside, and the second connection regions can be arranged perpendicular to the first flow direction or along the second flow direction or in the second flow direction relative to the first connection regions on the outside. This has the advantage that the first spacer can be connected independently and securely to the protective layer and to the membrane. In particular, the potentially negative influence of establishing one connection on another connection that has already been established can be ruled out.

At the respective first spacer, the respective membrane in the first connection region can lie perpendicular to the first flow direction or along the stacking direction or in the stacking direction above the respective protective layer. At the respective first spacer, the respective membrane in the second connection region can protrude above the respective protective layer perpendicular to the first flow direction or along the second flow direction or in the second flow direction. In other words, the respective membrane can be longer than the protective layer at the respective first spacer and thus lie directly against the first spacer in the second connection region. This allows the respective protective layer and the respective membrane in the first and second connection regions to lie directly against the respective first spacer and also to be directly connected to the respective first spacer in a material-locking manner. The respective first spacer can be connected first to the respective protective layer and then to the respective membrane, wherein the respective connection of the first spacer to the protective layer that has already been established does not adversely affect the subsequent connection of the first spacer to the membrane.

A width of the respective membrane defined perpendicular to the first flow direction or in the second flow direction may be greater than a width of the respective protective layer defined perpendicular to the first flow direction or in the second flow direction. In other words, the respective membrane can have a larger surface area than the respective protective layer. However, a width of the respective membrane defined perpendicular to the first flow direction or in the second flow direction may be equal to or approximately equal to a width of the respective first spacer defined perpendicular to the first flow direction or in the second flow direction. In other words, the respective membrane can have an area that is equal to or nearly equal to that of the respective first spacer. A width of the respective protective layer defined perpendicular to the first flow direction or in the second flow direction may be smaller than a width of the respective first spacer defined perpendicular to the first flow direction or in the second flow direction. In other words, the respective protective layer may have a smaller area than the respective first spacer. This allows both the protective layer and the membrane to lie directly against the first spacer and to be directly connected to the first spacer in a material-locking manner.

In one possible embodiment, the respective protective layer can be arranged perpendicular to the first flow direction or in the second flow direction centrally on the first spacer, so that the two edge-side second connection regions for connecting the first spacer to the membrane are exposed. The protective layer can then be directly bonded to the spacer at the edges of the respective first connection regions and parallel to the first flow direction. The membrane can then be arranged over the entire first spacer and completely cover the spacer and the protective layer. The membrane can then lie directly against the first spacer in the second connection regions and be directly connected to the first spacer in a material-locking manner. In the respective first connection region, the first spacer is then arranged in the stacking direction between the two protective layers and the two membranes. The protective layers are directly bonded to the first spacer, and the membranes lie loosely over the protective layers. The first spacer is then arranged between the two membranes in the respective second connection region. The respective membranes are directly connected to the first spacer with a tight fit.

The respective membrane can be formed in a single layer in particular. The respective membrane can be formed from a layer of a material which is permeable to water vapor and airtight. The respective membrane can, in particular, be formed exclusively from a single layer of a single-layer material which is permeable to water vapor and airtight. The single-layer membrane prevents delamination of the membrane during operation of the membrane stack, thereby preventing leakage of the membrane stack. The respective membrane can thus be formed separately from the respective protective layer.

The respective second spacer can be connected to the respective membrane adjacent to the respective second spacer in a material-locking manner, preferably by bonding or welding. The respective second spacer and the respective membrane can be located in two opposite third connection regions extending in the second flow direction at the edges, where they can lie directly against each other and be connected to each other in a material-locking manner. The channel through which the flow can pass in the second flow direction can then be formed between the two third connection regions on the edges. The respective channel is airtight, perpendicular to the second flow direction through the two third connection regions and in the stacking direction through the two membranes adjacent to the respective second spacer. For this purpose, the second spacer and the respective membrane can be connected to each other in an airtight manner in the respective third connection regions.

The respective first spacer and the respective protective layers connected to the respective first spacer in a material-locking manner and the membranes connected to the respective first spacer in a material-locking manner can form a prefabricated assembly. The prefabricated structural unit can be prefabricated during the manufacture of the membrane stack and then connected to the respective second spacers in a material-locking manner during the manufacture of the membrane stack. This simplifies the production of the membrane stack.

In one possible embodiment of the membrane stack, the respective first spacer for flow through with humid exhaust air flowing from the fuel cell and the respective second spacer for flow through with dry supply air flowing from the fuel cell may be designed. Since the dry supply air has a higher pressure than the humid exhaust air, the pressure in the channels formed by the second spacer is higher than in the channels formed by the first spacer. Accordingly, the membranes are always pressed against the first spacers. The protective layers are arranged between the first spacers and the membranes to protect the membranes from abrasion against the first spacers. However, no protective layers are required between the second spacers and the respective membranes. This reduces the manufacturing costs of the membrane stack.

The disclosure also relates to a method for manufacturing a membrane stack as described above. First, all initial spacers are connected to each other on both sides with a protective layer on the edges in sections and directly bonded to each other, preferably glued or welded. The first spacers with the protective layers and the respective second spacers and membranes are then stacked in a stacking direction and connected to each other at the edges in sections and in a material-locking manner, preferably by welding or bonding. In one possible embodiment, the first spacers with the protective layers and the second spacers and the membranes can be stacked one after the other in the stacking direction and thereby connected to one another in a material-locking manner. In an alternative embodiment, all first spacers with the protective layers can first be connected to each other on both sides with a membrane to form a prefabricated assembly. The respective structural units can then be stacked alternately one after the other in the stacking direction using the respective second spacers and connected in a form-fitting manner. In order to avoid repetitions, reference is made here to the above explanations.

The disclosure also relates to a humidifier for a fuel cell system with at least one fuel cell. The humidifier is specifically designed and intended for humidifying dry supply air flowing to the fuel cell with humid exhaust air flowing from the fuel cell. The humidifier features a membrane stack as described above and a housing. The membrane stack is housed in the housing and sealed to the housing in such a way that the dry supply air and the humid exhaust air can flow through the casing and the membrane stack without mixing. In addition, the membrane stack in the housing is aligned so that the humid exhaust air can flow through the membrane stack in the first flow direction through the first spacers and the dry supply air can flow through the membrane stack in the second flow direction through the second spacers. During operation, the humid exhaust air flows through the membrane stack in the first flow direction through the first spacers, and the dry supply air flows through the membrane stack in the second flow direction through the second spacers. Since the dry supply air has a higher pressure than the humid exhaust air, the pressure in the channels formed by the second spacer is higher than in the channels formed by the first spacer. This causes the membranes to be pressed against the first spacers during operation of the humidifier and not pressed against the second spacers. The respective protective layers between the first spacers and the membranes can protect the respective membranes. However, no protective layers are required between the second spacers and the respective membranes. This reduces the manufacturing costs of the membrane stack. In order to avoid repetitions, reference is made here to the above explanations.

Other important features and advantages of the disclosure can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the present disclosure.

Preferred exemplary embodiments of the disclosure are shown in the drawings by way of example and will be explained in more detail in the following description, wherein identical reference signs refer to identical or similar or functionally identical elements. Components that appear multiple times are marked with reference symbols for clarity.

### BRIEF DESCRIPTION OF THE DRAWINGS

They show, schematically in each case:

FIG. 1 shows an exploded view of a humidifier according to some implementations of the disclosure with a membrane stack according to some implementations of the disclosure;

FIG. 2 shows a sectional view of the membrane stack according to some implementations of the disclosure;

FIG. 3 shows a side view of a first spacer with protective layers of the membrane stack according to some implementations of the disclosure;

FIG. 4 shows a side view of the first spacer with protective layers and membranes of the membrane stack according to some implementations of the disclosure;

FIG. 5 shows a top view of the first spacer with protective layers of the membrane stack according to some implementations of disclosure with line-like connection; and

FIG. 6 shows a top view of the first spacer with protective layers of the membrane stack according to some implementations of the disclosure with point connections.

### DETAILED DESCRIPTION

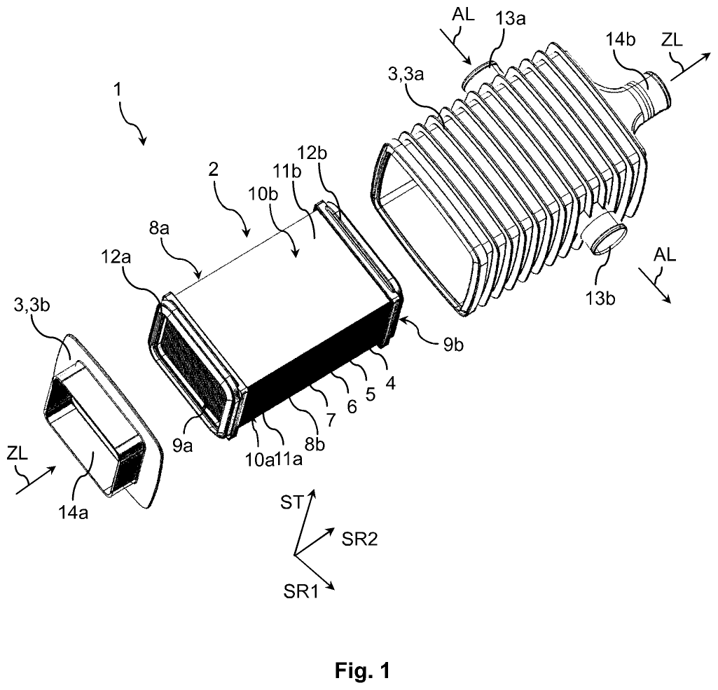

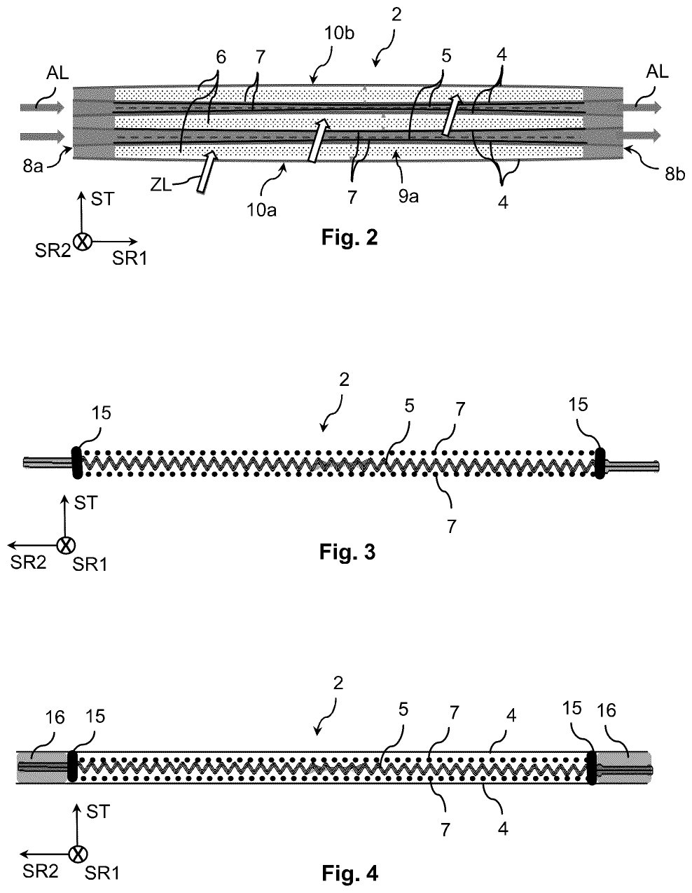

FIG. 1 shows an exploded view of a humidifier 1 according to some implementations of the disclosure. Humidifier 1 is designed for a fuel cell system with at least one fuel cell for humidifying dry supply air ZL flowing to the fuel cell with humid exhaust air AL flowing from the fuel cell. The humidifier 1 features a membrane stack 2 and a housing 3 according to some implementations of the disclosure. The membrane stack 2 has several flat membranes 4 stacked on top of each other in the stacking direction ST. The membranes 4 are permeable to water vapor and airtight. First spacers 5 and second spacers 6 are stacked alternately between the membranes 4. In addition, protective layers 7 are arranged between the respective first spacers 5 and the respective membranes 4 adjacent to the first spacers 5. The membranes 4, spacers 5 and 6, and protective layers 7 are connected to each other in a material-locking manner. The structure of membrane stack 2 is explained in more detail below with reference to FIGS. 2 through 6.

The membrane stack 2 is cuboid in shape and has two opposite outer sides 8a and 8b, two opposite outer sides 9a and 9b, and two opposite end sides 10a and 10b. The two outer sides 8a and 8b of the membrane stack 2 are connected to each other in such a way that humid exhaust air AL can flow through them in a first flow direction SR1 through the first spacers 5. The two outer sides 9a and 9b of the membrane stack 2 are connected to each other in such a way that dry supply air ZL can flow through them in a second flow direction SR2 through the second spacers 6. The two end faces 10a and 10b of the membrane stack 2 are formed by two sealing plates 11a and 11b, which are connected in an airtight manner to the respective last membranes 4 of the membrane stack 2, and cannot be penetrated by flow. Due to the stacking of the membranes 4 in the membrane stack 2, the outer sides 8a, 8b, 9a, 9b are parallel to the stacking direction ST and the end sides 10a and 10b are perpendicular to the stacking direction ST.

The membrane stack 2 is housed in the housing 3 and sealed in the housing 3 by means of two seals 12a and 12b surrounding the outer sides 8a and 8b and the sealing plates 11a and 11b, that the outer sides 8a, 8b, 9a, 9b are each separated from one another in an airtight manner. In this exemplary embodiment, the housing 3 has a pot-shaped housing body 3a and a cover 3b closing the housing 3a. Furthermore, an inlet 13a connected to the outer side 8a in a manner that allows air to pass through and an outlet 13b connected to the outer side 8b in a manner that allows air to pass through are formed in the housing 3, which are designed to feed the humid exhaust air AL to and from the membrane stack 2. In addition, an inlet 14a connected to the outside 9a in an air-conducting manner and an outlet 14b connected to the outside 9b in an air-conducting manner are formed in the housing 3, which are designed to supply and discharge the dry supply air ZL to and from the membrane stack 2.

When humidifier 1 is in operation, the humid exhaust air AL flows through inlet 13a into humidifier 1 and on to the outside 8a of the membrane stack 2. Then the humid exhaust air AL flows through the first spacers 5 or through the channels formed by the first spacers 5 in the membrane stack 2 from the outer side 8a to the outer side 8b. The humid exhaust air AL then flows out of humidifier 1 through outlet 13b. The dry supply air ZL flows through inlet 14a into humidifier 1 and on to the outside 9a of membrane stack 2. The dry supply air ZL then flows from the outer side 9a to the outer side 9b through the second spacers 6 or through the channels formed by the second spacers 6 in the membrane stack 2. The dry supply air ZL then flows from the outside 9b through the outlet 14b out of the humidifier 1. Since the membranes 4 are airtight, the dry supply air ZL and the humid exhaust air AL pass through the membrane stack 2 without mixing. And since the membranes are permeable to water vapor, the dry supply air ZL can be humidified by the humid exhaust air AL.

FIG. 2 shows a sectional view of a portion of the membrane stack 2 according to some implementations of the disclosure. The membrane stack 2 comprises several membranes 4, several first spacers 5, several second spacers 6, and several protective layers 7, which are connected to each other in a material-locking manner. The first spacers 5 and the second spacers 6 are arranged alternately in the stacking direction ST, and the membranes 4 are stacked between the spacers 5 and 6. The protective layers 7 are each arranged between the first spacers 5 and the adjacent membranes 4. In this exemplary embodiment, the membranes 4 are bonded to the spacers 5 and 6, and the protective layers 7 are welded to the first spacers 5.

The first spacers 5 connect the opposite outer sides 8a and 8b of the membrane stack 2 so that air can flow through them and are designed to allow the humid exhaust air AL to flow through. The second spacers 6 connect the opposite outer sides 9a and 9b of the membrane stack 2 to each other in a flow-through manner and are designed for the flow of dry supply air ZL. When humidifier 1 or membrane stack 2 is in operation, the dry supply air ZL has a higher pressure than the humid exhaust air AL. This presses the membranes 4 against the first spacers 5, as shown exaggeratedly in FIG. 2. The protective layers 7 between the membranes 4 and the first spacers 5 protect the membranes 4 from abrasion. No protective layers are necessary or provided between the second spacers 6 and the membranes 4.

FIG. 3 shows a side view of the first spacer 5 with the protective layers 7. The protective layers 7 are arranged on both sides of the first spacer 5 and are connected directly to the first spacer 5 at the edges in two opposing first connection regions 15, i.e., without any further intermediate layers. In this exemplary embodiment, the protective layers 7 are welded to the first spacer 5. The protective layer 7 is narrower than the first spacer 5, so that the first spacer 5 is exposed at the sides and outside the first connection regions 15.

FIG. 4 shows a side view of the first spacer 5 with the protective layers 7 and the membranes 4. The membranes 4 are arranged on both sides of the first spacer 5 and are connected directly to the first spacer 5 at the edges in two opposing second connection regions 16, i.e., without any additional intermediate layers. In this exemplary embodiment, the membranes 4 are bonded to the first spacer 5. For this purpose, the membranes 4 are wider than the protective layers 7 and extend laterally beyond the protective layers 7. In this embodiment, the membranes 4 are bonded to the first spacer 5. As a result, the first connection regions 15 and the second connection regions 16 are spaced apart from each other, and both the membranes 4 and the protective layers 7 are connected directly to the first spacer 5. This prevents delamination and leakage of the membrane stack 2.

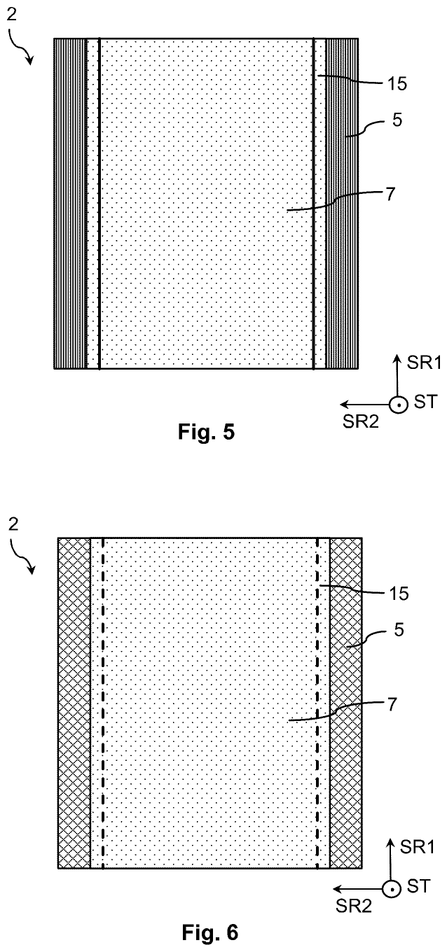

FIG. 5 shows a top view of the first spacer 5 with the protective layers 7. Here, the first spacer 5 has a wave structure and is connected or welded to the protective layers 7 in a linear fashion. FIG. 6 shows a top view of the first spacer 5 with the protective layers 7. Here, the first spacer 5 has a cross structure and is connected or welded to the protective layers 7 at specific points.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. All matter contained in the above description or shown in the accompanying drawings shall be interpreted as illustrative only and not limiting. Changes in detail or structure may be made without departing from the present disclosure.

1. A membrane stack for a humidifier of a fuel cell system with at least one fuel cell, the membrane stack comprising:
a plurality of membranes that are permeable to water vapor and airtight, the membranes arranged in a stacking direction, the membranes spaced apart from one another;
a plurality of first spacers and a plurality of second spacers, the first spacers and the second spacers arranged alternately between the membranes in the stacking direction,
wherein the membrane stack is configured to be flowed through in a direction perpendicular to the stacking direction, such that a first flow passes through the first spacers in a first flow direction and a second flow passes through the second spacers in a second flow direction, the second flow direction perpendicular to the first flow direction, and
wherein each first spacer is connected to an adjacent membrane at edge sections in a direct, material-locking manner; and
a protective layer is disposed between each first spacer and the adjacent membrane,
wherein each protective layer is connected to the adjacent first spacer at the edge sections in a direct, material-locking manner.

2. The membrane stack according to claim 1, wherein:
each first spacer and the respective protective layer adjacent to the first spacer are positioned in two first connection regions located on opposite sides of the first spacer, the first connection regions extending in the first flow direction and being directly adjacent to one another, the first spacer and the protective layer connected in a material-locking manner in the first connection regions, and/or
each first spacer and the respective membrane adjacent to the first spacer are positioned in two second connection regions located on opposite sides of the first spacer, the second connection regions extending in the first flow direction and being directly adjacent to one another, the first spacer and the membrane connected in a material-locking manner in the second connection regions.

3. The membrane stack according to claim 2, wherein the first connection regions and the second connection regions at each respective first spacer are spaced apart from one other in a direction perpendicular to the first flow direction.

4. The membrane stack according to claim 2, wherein at the respective first spacer, the first connection regions are positioned inward relative to the second connection regions in a direction perpendicular to the first flow direction, and the second connection regions are positioned outward relative to the first connection regions in the direction perpendicular to the first flow direction.

5. The membrane stack according to claim 2, wherein:
in each respective first connection region, the membrane is positioned above the adjacent protective layer in a direction perpendicular to the first flow direction, and/or
in each respective second connection region, the membrane extends beyond the adjacent protective layer in a direction perpendicular to the first flow direction.

6. The membrane stack according to claim 2, wherein:
each protective layer and the respective first spacer have a quadrangular cross-section in a plane perpendicular to the stacking direction, and the first connection regions are arranged on opposite sides of the protective layer and the first spacer, and/or
each membrane and the respective first spacer have a quadrangular cross-section in a plane perpendicular to the stacking direction, and the second connection regions are arranged on opposite sides of the membrane and the first spacer.

7. The membrane stack according to claim 1, wherein:
a width of each membrane, measured in a direction perpendicular to the first flow direction, is greater than a width of the respective protective layer, measured in the direction perpendicular to the first flow direction, and/or
a width of each membrane, measured in direction perpendicular to the first flow direction, is equal to a width of the respective first spacer measured in the direction perpendicular to the first flow direction, and/or
a width of each protective layer, measured in a direction perpendicular to the first flow direction, is less than a width of the respective first spacer measured in the direction perpendicular to the first flow direction.

8. The membrane stack according to claim 2, wherein each first spacer is connected to the adjacent protective layer at points or along a line, or over an area, in a material-locking manner.

9. The membrane stack according claim 1, wherein:
each respective membrane is formed in a single layer, and/or
each respective membrane is formed from a layer of a material that is permeable to water vapor and airtight, and/or
each membrane is formed from a single layer of a single-layer material which is permeable to water vapor and airtight.

10. The membrane stack according to claim 1, wherein:
each first spacer allows flow of humid exhaust air from the fuel cell, and
each second spacer allows flow of dry supply air to the fuel cell.

11. A method for manufacturing a membrane stack according to claim 1, the method comprising:
connecting all first spacers on both sides to respective protective layer at the edge section in a direct, material-locking manner, and
stacking the first spacers with the protective layers, the second spacers, and membranes in a stacking direction, and connecting the first spacers with the protective layer, the second spacers and the membranes to one another at the edge sections in a material-locking manner.

12. A humidifier for a fuel cell system with at least one fuel cell, the humidifier configured to humidify dry supply air flowing to the fuel cell using humid exhaust air flowing from the fuel cell, the humidifier comprising:
a membrane stack according to claim 1; and
a housing in which the membrane stack is accommodated and sealed, wherein the sealing prevents mixing of the humid exhaust air and the dry supply air while allowing both to flow through the housing and the membrane stack,
wherein the membrane stack is oriented within the housing such that that the humid exhaust air flows through the first spacers in the first flow direction, and the dry supply air flows through the second spacers in the second flow direction, the second flow direction perpendicular to the first flow direction.

13. The membrane stack according to claim 1, wherein each first spacer is connected to the adjacent membrane at the edge sections in the direct, material-locking manner including at least one of welding or gluing.

14. The membrane stack according to claim 1, wherein each protective layer is connected to the adjacent first spacer at the edge sections in the direct, material-locking manner including at least one or welding or gluing.

15. The membrane stack according to claim 3, wherein at the respective first spacer, the first connection regions are positioned inward relative to the second connection regions in a direction perpendicular to the first flow direction, and the second connection regions are positioned outward relative to the first connection regions in the direction perpendicular to the first flow direction.

16. The membrane stack according to claim 3, wherein:
in each respective first connection region, the membrane is positioned above the adjacent protective layer in a direction perpendicular to the first flow direction, and/or
in each respective second connection region, the membrane extends beyond the adjacent protective layer in a direction perpendicular to the first flow direction.

17. The membrane stack according to claim 4, wherein:
in each respective first connection region, the membrane is positioned above the adjacent protective layer in a direction perpendicular to the first flow direction, and/or
in each respective second connection region, the membrane extends beyond the adjacent protective layer in a direction perpendicular to the first flow direction.

18. The membrane stack according to claim 3, wherein each first spacer is connected to the adjacent protective layer at points or along a line, or over an area, in a material-locking manner.

19. The membrane stack according claim 2, wherein:
each respective membrane is formed in a single layer, and/or
each respective membrane is formed from a layer of a material that is permeable to water vapor and airtight, and/or
each membrane is formed from a single layer of a single-layer material which is permeable to water vapor and airtight.

20. The membrane stack according to claim 2, wherein:
each first spacer allows flow of humid exhaust air from the fuel cell, and
each second spacer allow flow of dry supply air to the fuel cell.
